(19) United States
(12) Patent Application Publication
(10) Pub. No.: US 2023/0284656 A1
(43) Pub. Date: Sep. 14, 2023

(54) INTERACTIVE ACTIVE ROPE PET CHEW AND METHODS OF MAKING

(71) Applicant: Spectrum Brands, Inc., Middleton, WI (US)

(72) Inventors: Tiffany Dawn POTTER, Pearisburg, VA (US); Gregory VAN EYK, Christiansburg, VA (US); Allyse MCCANN, Blacksburg, VA (US)

(73) Assignee: Spectrum Brands, Inc., Middleton, WI (US)

(21) Appl. No.: 18/004,616

(22) PCT Filed: Jul. 8, 2021
(86) PCT No.: PCT/US2021/040844

§ 371 Date: Jan. 6, 2023

Related U.S. Application Data
(60) Provisional application No. 63/049,455, filed on Jul. 8, 2020.

(51) Int. Cl. A23K 40/00; A23K 50/40; A23K 10/20; A23K 10/30; A23K 20/179

(52) U.S. Cl. CPC A23K 40/00; A23K 10/20; A23K 10/30; A23K 20/179; A23K 50/40

(57) ABSTRACT

Compositions and methods for making an interactive and playful pet chew are described herein. The pet chew comprises a chew stick having a longitudinal axis and one or more portions disposed onto the chew stick. The one or more portions are configured to be rotatable around the longitudinal axis and/or movable along the pet chew. The present pet chew provides a complex and changeable configuration and compositions of balanced nutrition.

### CROSS-REFERENCE TO RELATED APPLICATION

This application is a PCT International Patent Application and claims priority to U.S. Provisional Pat. Application No. 63/049,455, filed Jul. 8, 2020; the disclosure of which is hereby incorporated by reference in its entirety.

### INTRODUCTION

Traditional pet treat or pet chew products consist essentially of rawhide or dehydrated rawhide, which has high density and toughness. Although rawhide can sustain chewing in a dog’s mouth for relatively long time, it actually does not maintain a dog’s interest due to the limited acceptability. Manufacturers have attempted to solve this problem of reduced acceptability by incorporating numerous ingredients and processing techniques into the manufacture of rawhide-based chews for dogs, such as incorporating meat in the middle of a rawhide stick.

Despite this, the basic problem remains. As ingredients or processing techniques are utilized with rawhide to increase palatability, they typically weaken the basic structure of the rawhide and produce a less acceptable product from the standpoint of extended chew time. Further, the rawhide stick does not provide a visually appealing treat for dog. The pet treat also does not give the pet owner a visually acceptable reaction when purchasing the pet treat. What is needed is a pet treat that provides a visually appealing product that stimulates a human to purchase the pet treat. What is needed is a pet treat that provides a palatable product for a pet and can provide an initial taste reward, but also gives the dog a chew portion for sustained pet treat duration.

Some commercial pet treats utilizing rawhide as dog treats have taken the approach of incorporating a meat fraction in conjunction with the rawhide to significantly increase the palatability of the chew. For example, U.S. Pat. No. 5,673,653 to Sherrill discloses a product and process of wrapping jerky sheets on the inside of a roll of rawhide. U.S. Pat. No. 6,277,420 to Andersen demonstrates a method of making a preformed rawhide tube and depositing a shelf-stable liquid meaty filling into the cavity of the tube which gels and then forms a solid matrix on the inside of the rawhide. U.S. Pat. No. 6,886,496 to Brown discloses a pre-extruded dried meaty log that could be placed inside of a rolled rawhide cylinder. However, these multi-component pet chews or treats have a nearly permanent configuration, with the consumable component (such as the meat portion) and the rawhide stick integrated into the pet treats in a fixed position. Further, the position of each component relative to each other is also fixed, which bores the animal over time because of the less interactive configuration.

Thus, it is highly desirable for new pet chews that are more interactive with animals. It is also desirable for pet chews having unique configurations with movable components that can also be consumed.

### INTERACTIVE ACTIVE ROPE PET CHEW AND METHODS OF MAKING

### Summary of Disclosure

In some aspects, the present disclosure relates to a pet chew comprising: a chew stick having a longitudinal axis; and one or more portions disposed onto the chew stick, wherein the one or more portions are rotatable around the longitudinal axis.

In some embodiments of the present disclosure, each of the one or more portions has a hole (or opening or cavity or channel or the like) through the portion, and the one or more portions are strung onto the chew stick through the hole(s) positioned in approximately the center of each of the one more portions. In embodiments, the chew stick has a major body extended from a first end to a second end, wherein major body has a substantially uniform cross-section through a length of the major body. In embodiments, the first end and the second end each has a larger cross-section in size or circumference relative to the major body. In embodiments, the hole of each of the portions is larger in size relative to the cross-section of the major body, such that the one or more portions can both rotate around the major body and move along the major body. In embodiments, the first end the second end are larger in size relative to the hole of each of the one or more portions, thereby preventing the portions from sliding off the pet chew. In embodiments, the present pet chew further comprises at least one knot disposed at the first end or the second end or both, wherein the knot(s) is larger in size relative to the hole of each of the one or more portions. In embodiments, the chew stick of the present pet chew is substantially straight.

In some embodiments of the present pet chew, the number of the portions is at least 1, at least 2, at least 3, at least 4, at least 5, at least 6, least 7, at least 8, at least 9, at least 10, at least 11, at least 12, least 13, at least 14, at least 15, at least 16, at least 17, at least 18, least 19, at least 20, at least 21, at least 22, at least 23, at least 24, or least 25.

In some embodiments, at least one of the portions of the present pet chew has a disk-like configuration. In embodiments, at least one of the portions has a substantially round shape. In embodiments, the pet chew comprises two or more portions and wherein the two or more portions are substantially the same in shape, size, and thickness. However, while not wanting to be bound by any particular shape, triangles, square, rectangles may also be used. It should also be appreciated that the pet chew may comprise several portions that are different shapes and/or sizes. In embodiments, the one or more portions have a thickness from about 0.1 cm to about 5 cm, or from about 0.2 cm to about 4 cm, or from about 0.3 cm to about 3 cm, or from about 0.4 cm to about 2 cm, or from about 0.5 cm to about 1 cm.

In some embodiments, the chew stick of the present pet chew comprises rawhide. In other embodiments, the chew stick is substantially free from rawhide. In some embodiments, the chew stick comprises a natural animal portion selected from the group consisting of pizzle, bone, tendon, ligament, sinew, weasand (esophagus) and combinations thereof.

In some embodiments of the present pet chew, the one or more portions comprise a meat selected from the group consisting of pork, beef, chicken, duck, goat, horse, buffalo, venison, deer, elk, moose, liver, fish, veal, lamb, turkey, goose and combinations thereof.

In some embodiments, the one or more portions of the pet chew comprise a plant selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugh fruit and combinations thereof.

In some embodiments, the one or more portions of the pet chew comprise a plant selected from a group consisting of artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

In some embodiments, the one or more portions of the pet chew comprise one or more auxiliary ingredients selected from the group consisting of a binding agent, a moisturizing compound, a salt, a sugar, an acid, a mold inhibitor, a flavoring compound, an aroma compound, a coloring compound and any combination of two or more thereof.

In some embodiments, the present pet chew further comprises a food additive selected from the group of preservative, sorbitol, desired colorant, glycerin, yeast extract, flavor, salt, cochineal, potassium sorbate, or combinations thereof.

In some embodiments, the present pet chew further comprises a health ingredient selected from the group consisting of glucosamine, chondroitin, flax seed, calcium, parsley seed, peppermint, chlorophyll, vitamin E, L-carnitine, and lycopene, and combinations thereof.

In some embodiments, the present pet chew further comprises one or more coloring compounds selected from a group consisting of caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof.

In some aspects, the present disclosure relates to a process of making a pet chew described herein. The process comprises providing a chew stick, the chew stick having a longitudinal axis; and disposing one or more portions onto the chew stick, wherein each of the one or more portions are rotatable around the longitudinal axis.

In some embodiments of the present process, the disposing step comprises: providing one or more portions, each portion having a hole; and positioning the one or more portions onto the chew stick through the hole(s). One example of positioning could be stringing the one or more portions on the chew stick.

In some embodiments of the present process, the chew stick has a major body extended from a first end to a second end, wherein major body has a substantially uniform cross-section through a length of the major body. In some embodiments, the present process further comprises a means to configure the first end and the second end of the chew stick, such that the first end the second end are larger in size or circumference relative to the hole of each of the one or more portions, thereby preventing the portions from sliding off the pet chew. In some embodiments, the chew stick is formed by twisting a rawhide sheet, and wherein the means to configure the first end and the second end of the chew stick comprises making a tied knot at each of the first end and the second end of the twisted rawhide sheet.

In some embodiments, the present process further comprises drying or dehydrate the pet chew at an elevated temperature to form the final pet chew product.

### Definitions

As used herein, “weight percent,” “wt%, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt%, etc.

As used herein, “g” represents gram; “oz” represents ounce, and one ounce is equivalent to about 28.35 g; “L” represents liter; “mg” represents “milligram (10⁻³ gram);” “mL” represents milliliter (10⁻³ liter); “cm” represents centimeter (10⁻² meter); “mm” represents millimeter (10⁻³ meter); one inch is equivalent to about 2.54 cm. The unit of temperature used herein is degree Celsius (°C).

The term “about” is used in conjunction with numeric values to include normal variations in measurements as expected by persons skilled in the art, and is understood have the same meaning as “approximately” and to cover a typical margin of error, such as ± 10 % of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### BRIEF DESCRIPTION OF THE DRAWINGS

FIG. 1 illustrates an embodiment of the pet chew according to a present disclosure.

FIG. 2A illustrates a perspective view of a portion of the pet chew.

FIG. 2B illustrates a top view of a portion of the pet chew.

### DETAILED DESCRIPTION

The present disclosure provides a composition and process for making pet food treats or pet chews. In some aspects, the present disclosure relates to a pet chew comprising: a chew stick having a longitudinal axis; and one or more portions disposed onto the chew stick, wherein the one or more portions are rotatable around the longitudinal axis. In some aspects, the present disclosure relates to a process of making a pet chew described herein. The process comprises providing a chew stick, the chew stick having a longitudinal axis; and disposing one or more portions onto the chew stick, wherein each of the one or more portions are rotatable around the longitudinal axis.

The present disclosure is based upon the discovery that chews having a multi-component structure and a complex and changeable configuration will visually stimulate an animal and increase an animal’s interest in playing with the chew as well as consuming the chew. While not bound by theory, it is believed that the multi-component structure provides a unique appearance that is appealing to animals. Each of the portions is rotatable around the chew stick. In other related embodiments the portions are both rotatable and movable along the chew stick, which is surprisingly playful and interactive, compared with other pet treats having a meat portion with a fixed configuration. The chew stick as an inner portion and carrier of the portions remains the advantages such as high toughness and strength. In addition, the pet chew may provide a balanced and healthier diet, allowing the animal to have intake of both meat and plant-based ingredient concurrently when eating the pet chew.

### Pet Chew

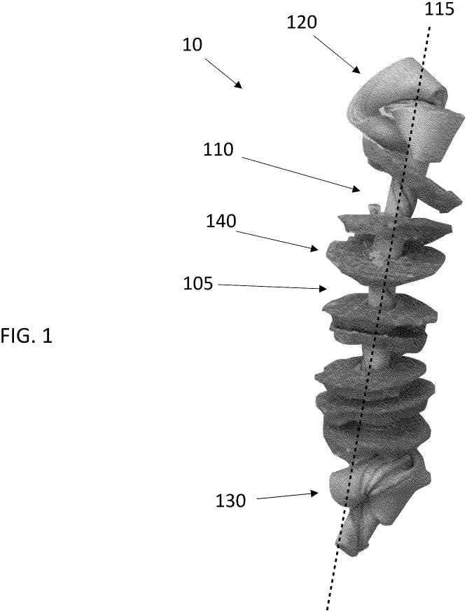

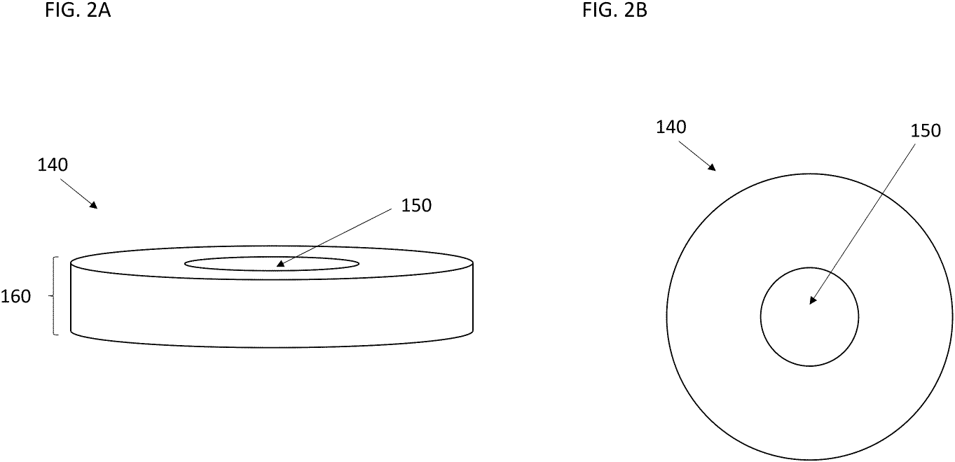

Now referring to FIGS. 1, 2A and 2B, particular embodiments of the pet chew will be described. Pet chew 10 comprises a chew stick 105 having a major body 110, a first end 120 and a second end 130 along a longitudinal axis 115. In some embodiments, the chew stick 105 is substantially straight. In other embodiments, chew stick 105 is curved, or has at least one curvature along the longitudinal axis 115. In some embodiments, the major body 110 has a substantially uniform cross-section through a length of the major body 110. The pet chew 10 comprises one or more portions 140. The one or more portions 140 are disposed onto the major body 110. Each portion is circumferentially around the major body 110. In a particular example, as shown in FIGS. 2A and 2B, each of the one or more portions has a hole (or an opening or a cavity or a channel or the like) 150 through the portion 140 at approximately the center of the portion. The hole 150 is in a larger size or circumference relative to the cross-section of the major body 110. The one or more portions are 140 are therefore able to be strung onto the major body 110 of the chew stick 105 through the hole(s). In addition, the one or more portion(s) 140 is configured to be both rotatable relative to the chew stick 105 around the longitudinal axis 115, and slidable or movable along the major body 110 of the chew stick 105.

In some embodiments, each of the first end 120 and the second end 130 is enlarged, such that a maximum cross-section thereof is larger in size or circumference relative to both the major body 110 and the hole 150 of the portion(s) 140. In such way, the one or more portions 140 are prevented from sliding off the chew stick 105. However, the two ends 120 and 130 may not obstruct the free rotation and/or motion of the portion(s) 140 relative to the chew stick 105, as described above.

In some embodiments, the chew stick 105 has a bone-like or dumbbell-like shape (not shown). The two ends 120 and 130 are enlarged in size relative to the major body 110. At least one of the two ends 120 and 130 is removably attached to the major body 110. When one end 120 or 130 or both are removed from the major body 110, portion(s) 140 can be strung onto the major body 110. Then the removed end(s) can be re-attached to the major body 110, securing the portion(s) 140 between the two ends.

In some embodiments, the chew stick 105 comprises at least one knot or a tied structure or the like disposed at each of the first end 120 and the second end 130. The knot(s) is configured to be larger in size or circumference of cross-section relative to the hole 150 of each of the one or more portions 140. The knot(s) could be removably attached to the major body 110 in a way similar to the bone-like chew stick described above, allowing the portion(s) 140 to be strung onto the chew stick. Alternatively, the knot(s) would be made by tying the ends into a knot(s). For example, the chew stick may be made from a rawhide sheet. Typically, the chew stick can be made by soaking a rawhide sheet, and then twisting the rawhide thereby forming a rawhide chew stick with a desired length and size, and then drying the rawhide chew stick. The one or more portion(s) 140 can be placed onto the rawhide chew stick, and subsequently the ends of the rawhide chew can be tied into desired knots or knotted structures before the rawhide chew stick is hardened. Similarly, the knot(s) is configured to be larger in size relative to the hole 150 of the portion(s) 140.

The chew stick 105 may also comprise a natural animal portion, including but not limited to pizzle, bone, tendon, ligament, sinew, weasand (esophagus) and combinations thereof. The natural animal portion may be derived from a buffalo, bull, camel, cow, steer, deer, donkey, fish, goat, horse, sheep, swine or a combination of two or more thereof. As a non-limiting example, the chew stick 105 is a pizzle, more specifically, a bovine penis that is generally obtained frozen, although fresh bovine penis can also be utilized. Another particular example of the chew stick is bovine tendon, which has a rich source of collagen.

Alternatively, the chew stick 105 may be free or substantially free from rawhide. For example, the chew stick may be made from a plant-based material that mimics the characteristics of rawhide.

In some embodiments, the pet chew 10 comprises at least 1, at least 2, at least 3, at least 4, at least 5, at least 6, least 7, at least 8, at least 9, at least 10, at least 11, at least 12, least 13, at least 14, at least 15, at least 16, at least 17, at least 18, least 19, at least 20, at least 21, at least 22, at least 23, at least 24, or least 25 portions 140. In embodiments, the pet chew 10 comprises 1 to 25, or 2 to 20, or 3 to 15, or 4 to 10, or 5 to 8 portions 140. The optimal number of the portions 140 will depend on the length of the major body and the thickness of each of the portion(s).

The portion(s) 140 may have various shape, size, and configuration. For example, the portion(s) 140 may resemble a ball, a cube, a cuboid, a cylinder, a cone, a prism, a pyramid, a ring, a disk, or an irregular shape. As a particular example, at least one of the portions 140 has a disk-like configuration. The disk-like portion may have a substantially round planar shape, but other shapes are also possible, for example, square, rectangular, triangle, oval, etc.

The portion(s) 140 may vary in size although portions between 0.1 cm and 10 cm are typical. The portions will typically range in weight, but will be between 0.05 and 5 oz. As noted above, the geometrical shape of the portions can be selected as desired, such as round or flat. In addition, the portions can be shaped so as to form, generally round-shaped meat pieces (generally referred to as meatballs), cubic-shaped meat pieces, cylindrical-shaped meat pieces (for example, meat pieces resembling sausages), polygonal-shaped meat pieces, pyramid shaped meat pieces, heart-shaped meat pieces, flat-wafer shaped, or other more complex-shaped meat pieces. Moreover, in embodiments where multiple portions are used, the portions may be different in shapes and/or sizes to provide alternative products.

The portion(s) 140 with a disk-like configuration as shown in FIGS. 2A and 2B may have a thickness 160 from about 0.1 cm to about 5 cm, or from about 0.2 cm to about 4 cm, or from about 0.3 cm to about 3 cm, or from about 0.4 cm to about 2 cm, or from about 0.5 cm to about 1 cm.

In some embodiments, the pet chew 10 comprises two or more portions and wherein the two or more portions are substantially the same with respect to shape, size, and thickness.

### Composition and Method of Making the Pet Chew

The composition and method of making a pet chew are described herein. The process comprises providing a chew stick, the chew stick having a longitudinal axis; and disposing one or more portions onto the chew stick, wherein each of the one or more portions are rotatable around the longitudinal axis. In embodiments, the disposing step comprises: providing one or more portions, each portion having a hole; and positioning, such as stringing, the one or more portions onto the chew stick through the hole(s). In embodiments, the process further comprises dying the pet chew.

The process generally comprises forming a foodstuff comprising a meat or a meat base into portions 140. The meat base is made from animal meat and may comprise boneless chicken, duck, chicken liver and combinations thereof. The animal meat may be fresh, dehydrated, powdered, and extract or frozen. The frozen animal meat is defrosted at about 0° C. to about 5° C. Once the animal meat is defrosted, the animal meat is weighed. Once the predetermined amount of animal meat is weighed, the meat is placed in a grinder, the animal meat(s) is ground and mixed with the specific desired ratio of animal meat(s) and stored in a container as a meat base. It should be noted that the meat base may be frozen for later use, or may be used immediately after the meat base is prepared. Further, one should appreciated that although boneless chicken, duck and chicken liver are noted, the meat base can also include beef, pork, lamb, goat, horse, buffalo, venison, elk, moose, chicken, turkey, fish, or any other seafood, or any combination of two or more thereof. Alternatively, the meat base need not include boneless chicken, duck and/or chicken liver and may comprise beef, pork, lamb, goat, horse, buffalo, venison, elk, moose, bone-in chicken, turkey, fish, or any other seafood, or any combination of two or more thereof. The term “meat” associated with “meat base” and “meat mixture” are intended to encompass parts of animals, mammal and non-mammal, that can be used for a pet chew. This includes but is not limited to soft tissue, internal organs, cartilage and bone.

In one embodiment of the disclosure, chicken meat is used as a meat base. Chicken meat can include, for example, necks, breasts, or backs, or any combination of two or more thereof, with or without cartilage and/or bone ground to small sizes (i.e., emulsified). Chicken meat can also include necks, breasts, or backs, or any combination of two or more thereof that are boneless and ground to desired sizes. Chicken meat can include mechanically separated chicken (MSC). Chicken meat can also include a mixture of boneless or bone-in chicken, mixed together in various portions. The chicken meat is used in an amount of about 5-100% by weight of the meat mixture. It should be appreciated that the other animal sources, including various sections of the animal can be used to provide a final taste or consistency for the meat. In embodiments where other meat sources are used, the total meat content is 5% to 100% by weight of the meat mixture.

The foodstuff for the portion(s) 140 may comprise a plant base. The plant base is made from a plant base material. Such as a fruit, vegetable, vegetable protein, fruit extract, vegetable extract and combinations thereof that can be consumed by a domestic pet. The plant material may be fresh, dehydrated, powdered, an extract or frozen. In embodiments where the plant material is frozen the plant material is defrosted at about 0° C. to about 5° C. Once the plant material is defrosted, the plant material is weighed. Once the predetermined amount of plant material is weighed, the plant material is placed in a grinder, the plant material(s) is ground and mixed with the specific desired ratio of plant material (s) and stored in a container as a plant base. It should be noted that the plant base may be frozen for later use, or may be used immediately after the plant base is prepared. In one example embodiment, the plant base does not include any meat product, Such as beef, pork, lamb, goat, horse, buffalo, venison, elk, moose, bone-in chicken, turkey, fish, or any other seafood.

A plant base material, as used herein, means a fruit, vegetable, vegetable protein, fruit extract and vegetable extract that can be consumed by a domestic pet, such as a dog.

In one embodiment of the disclosure, the plant base may include fruits such as, apple, apricot, banana, black berry, blackcurrant, blueberry, coconut, cherry, cherimoya, date, durian, fig, feijoa, gooseberry, grape, grapefruit, jack fruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, Strawberry, tangerine, ugli fruit and combinations thereof.

The plant base may include vegetables such as, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, Sweet potato, tomato, turnip, water chestnut, yams, and combinations thereof.

Pet chew 10 may also include a starch composition which comprises any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 6-80% including but not limited to 10%, 15%, 20%, 25%, 30%, 35%, 40%, 45%, 50%, 55%, 60%, 65%, 70%, 75% and 80%. Alternatively, the starch composition may be at least 10%, 15%, 20%, 25%, 30%, 35%, 40%, 45%, 50%, 55%, 60%, 65%, 70%, 75% or 80%.

In some embodiments, starch is used to provide structural support to the foodstuff for the portion(s) 140. The starch employed herein may be raw starch, which may be understood as starch that has not seen a prior thermal molding history, such as extrusion or other type of melt processing step. The raw starch itself may also be native, which may be understood as unmodified Starch recovered in the original form by extraction and not physically or chemically modified. The raw starch may also be in powder form of varying particle size, which may be understood as milled and/or pre-sifted. It should be understood that the raw starch may also have varying degrees moisture present. The starch composition may include cellulose. The cellulose may be, for example, a long-chain polymer of polysaccharide carbohydrate. The cellulose may also be derived or extracted from plants. The cellulose may be incorporated into the starch composition between about 1-10% by weight of the starch composition.

Additionally, herbs, herbal extracts, vitamins, minerals, yeast products, soy products, may be incorporated into the plant base. Further, the plant base may also include food sources that provide phytochemicals. A non-exclusive list phytochemicals include: carotenoids, lycopenes, beta cryptozanthin, flavonoids, indoles, Sulforaphane, isoflavones, allicin, genistein, polyphenols, anthocyanins, limonoids, sterols, capsaicin, elegiac acid and lignans.

In one example embodiment, carotenoids are included in the plant base. In at least this example embodiment the carotenoids are included from a plant selected from a group consisting of carrots, cantaloupe, papaya, pumpkin, squash, sweet potatoes, broccoli, dried apricots, asparagus, kale, green leafy vegetables and combinations thereof. In related embodiments, lycopenes are included in the plant base. The lycopenes are added with the addition of plants selected from a group consisting of tomatoes, tomato paste, tomato juice, guava, pink grapefruit, watermelon and combinations thereof. In other related embodiments, beta cryptozanthin are included in the plant base. Beta cryptozanthin are found in plants such as tangerines, papaya, oranges, peaches, mangoes, nectarines and combinations thereof.

In other example embodiments flavonoids extracted from plants such as soy, green tea, tomatoes, sweet potatoes, cruciferous vegetables such as broccoli, cabbage, brussels sprouts, mustard greens, kale, and cauliflower, citrus fruits, onions and combinations thereof can be used in the plant base. In other example embodiments, indoles and sulforaphane, which are commonly found in cruciferous vegetables, are added to plant base. Examples of cruciferous vegetables include, but are not limited to cauliflower, cabbage, garden cress, bokchoy, broccoli and brussels sprouts. in other related embodiments, isoflavones are included in plant base. Isoflavones are commonly found in legumes, Such as beans, peas and lentils and soy products. In other related embodiments, allicin is added to the plant base, which can be found in plants such as onions and garlic. In example embodiments, genistein is added through the addition of soy products, such as tofu. In other example embodiments, polyphenols can be added through the addition of green tea.

In yet other related embodiments, anthocyanins found in plants such as wild blueberries, bilberries and black berries can be included in plant base. Limonoids, found in citrus fruits such as clementine, grapefruit, kumquat, lemon, lime, mandarin, orange, tangerine and the like can also be added to plant base. In other embodiments, sterols from cruciferous vegetables, cucumbers, squash, sweet potatoes, soy foods, eggplant, whole grains, tomatoes and the like are included in plant base. In embodiments where the addition of capsaicin is desired, the phytochemical can be added by including chili peppers. Similarly, in embodiments where elegiac acid is desired strawberries can be included in plant base. The addition of lignans, can be achieved by the addition of nuts and seeds. It should be appreciated that the addition of certain plants will include more than one phytochemical listed herein. Further, extract(s) of the aforementioned plants can be added to specifically add a desired phytochemical or combination of phytochemicals to the plant base.

Other sources of important nutrients for animals may also include seaweed, kelp, bluegreen algae, Spirulina, Irish moss, dulse, nori, kombu, wakeme, alfalfa, fenugreel seed, wheatgrass, barleygrass and marine phytoplankton.

The plant material is used in an amount of about 5% to 100% of the foodstuff for the portion(s) 140. It should be appreciated that the other plant sources, including various extracts, can be used to provide a final taste or consistency for the foodstuff for the portion(s) 140. In embodiments where other plant sources are used, the total plant content is 6% to 90% by weight of the entire foodstuff for the portion(s) 140. As noted herein, the foodstuff comprising the plant base may optionally comprise beef, pork, lamb, goat, horse, buffalo, venison, elk, moose, chicken, turkey, fish, or any other seafood, or any combination of two or more thereof.

Now the composition and process of forming a chew stick is described herein. The process includes, but is not limited to the use of rawhide, or other similar materials to form an elongated section. It should be appreciated that the chew stick, as described herein may be made from several processes available to one skilled in the art; for example, extrusion, molding and the like are within the scope of the disclosure. In one example embodiment, the chew stick is prepared by shaping a piece of rawhide to form an elongated chew. For example, chew stick is manufactured by taking a rawhide sheet and twisting the sheet to form an elongated stick-shape chew. In another example embodiment, a first rawhide sheet is cut to an appropriate size and a second sheet of rawhide is also cut in the shape of a similarly sized proportion. The first sheet and second sheet may be rawhide from different animals. In at least this example embodiment, the second sheet is a pork rawhide. Each rawhide sheet is soaked in a potassium sorbate solution. The potassium sorbate solution may be 0.5%. Moreover, the second sheet has color agents added to enhance the overall appearance of the sheet. In this manner, the second sheet will provide a darker meat-like color to provide an additional visual enhancement for the overall pet chew. The second rawhide sheet may be colored with Color Blue, Red 40, and Yellow. It is important to note that the concentrations listed are representative of concentrations that can be utilized. However, one of ordinary skill in the art would readily appreciate that the physical characteristics and animal origin of the rawhide may require modifications in the combinations and concentrations of each coloring agents to achieve a desired chew stick appearance. The sheets of rawhide may also be flavored according to one of the processes described herein.

The second sheet is placed upon the first sheet in the same general orientation, the two rawhide sheets are twisted together, as described, to make a multi-component chew stick. Once the rawhide sheets are twisted together, they are dried. In one example embodiment the chew stick is dried in an oven at 40° C. to 65° C. for 4 to 5 hours. Upon removing the dried chew stick from the oven, the sticks are allowed to cool to allow for ease in handling.

In some example embodiments, at least one rawhide section is soaked in a potassium sorbate solution prior to forming said chew stick. One skilled in the art can readily ascertain the precise concentration needed to provide sufficient anti-mold activity. For example, one concentration includes a concentration of potassium sorbate at 0.5% v/v. The chew stick can be formed in a variety of ways. In order to achieve a dual component appearance, one rawhide piece may be twisted where a portion of chew stick is colored to provide the appearance of a multi-layered chew stick. In some related embodiments, the at least two rawhide pieces are from different animal sources.

As another example, the chew stick 10 is prepared by shaping a piece of pizzle to form an elongated chew. Pizzle is formed from a bovine penis that is generally obtained frozen, although fresh bovine penis can also be utilized. In embodiments where the bovine penis is frozen the bovine penis is defrosted. The bovine penis is then dehydrated in an oven at 40° C. to 65° C. for 5 to 7 hours. Prior to dehydration, the bovine penis may optionally be stretched to alter final length, width and curvature of the pizzle stick. In other related preparation methods, pizzle sticks are obtained by taking bovine penises and removing any unwanted fat or membranes from the penis. In related embodiments, the pizzle stick can be made from bovine penis that is cut lengthwise, into halves or quarter sections. Segmentation of the bovine penis prior to dehydration may provide an alternative option to prepare the chew stick 10.

Once the dehydration step is finished the bovine penis will be baked at a temperature of greater than or equal to about °C. Once the bovine penis is baked, the final product results in a pizzle stick. The pizzle stick is then optionally cut and sized to form a chew stick. It is important to note that although pizzle aticks that are removed from the oven may be used once cooled to a workable temperature, they can also be stored at room temperature for future use. In other related embodiments, the cut pizzle sticks may be optionally twisted. The pizzle stick may also be flavored according to one of the processes described herein.

When at least two pizzle stick portions is desired the second pizzle stick is placed upon the first pizzle Stick in the same general orientation, as described, the two pizzle sticks are twisted together to make a multi-component chew stick. Once the pizzle sticks are twisted together, they are dehydrated. In one example embodiment, an additional drying step is performed where the chew Stick is dried in an oven at 40° C. to 65° C. for 4 to 5 hours. The chew sticks are allowed to cool to allow for ease in handling. As described above, the dried pizzle stick is removed from the oven, where the pizzle stick (now designated as a chew stick) is further processes or stored for later use.

Alternatively, the chew stick can be artificial, or made from non-animal origin such as plant-based material. The chew stick may comprise multiple pieces that are removably attached to form the chew stick. As discussed previously, for example, the chew stick comprises a elongated major body and two ends that resemble a bone. The two ends are larger in size or cross-section relative to the major body, and at least one of the two ends is configured to be removably attached to the maj or body through a means of attachment such as adhesive or screw. Each piece (the major body and the ends) can be independently made by standard industrial process such as injection molding. One skilled in the art will appreciate the parts, facilities, and operational parameters to arrive at the multiple parts of the chew stick with desired features. The chew stick could be assembled by integrating the multiple pieces, for example, attaching the ends to the major body.

Referring now to example methods of receiving, storing, and processing base material to form the foodstuff for portions(s) 140 will be described. The meat or meat base can be stored at sub-zero temperatures, although fresh meat base is also within the scope of the disclosure. The frozen meat base is ready for further processing by thawing the meat base. In some example embodiments, meat base is thawed using a microwave. Alternatively, the meat base can be thawed by other devices known by one of ordinary skill in the art. One such alternative device is a tempering device.

The frozen containers (i.e. bags) of meat base are thawed and the meat base is placed in a tumbler to begin the process of forming a meat mixture. Once the meat base begins the tumbling process, the meat base is combined with auxiliary ingredients forming a meat mixture. The meat base can be used in an amount between about 5% and about 100% by weight of the meat mixture, for example about 60% by weight of the meat mixture. In some example embodiments, the meat base and auxiliary ingredients can optionally be subjected to a vacuum to form a homogeneous meat mixture. The vacuum can remove entrapped air and can provide a denser and more homogenous blend. The vacuum can be applied at a level from about 0 to about 30 mm/Hg.

The meat mixture is prepared by mixing the meat base with auxiliary ingredients that may include a binding agent, a salt, a sugar, an acid, a mold inhibitor, a flavoring compound, an aroma compound, a coloring compound, a moisturizing compound or any combination of two or more thereof.

The binding agent can be used in an amount between about 10% and about 75% by weight of the meat mixture. In one example embodiment the binding agent is about 20% by weight of the meat mixture. The type and amount of binding agent can be selected so that the resulting product is not sticky and no residue is left on the pet owners finger-tips or households surfaces, such as carpets. For example, the binding agent can be added to “buffer or to absorb fat content in the meat mixture. The binding agent can also facilitate the blending of the various ingredients and allow the meat mixture to hold a shape prior to being dried.

The binding agent can include, but is not limited to, oat flour, soy flour, wheat flour, rice flour, potato flour, corn flour, rye flour, buckwheat flour, chestnut flour, chickpea flour, atta flour, pea flour, bean flour, amaranth flour, arrow root flour, taro flour, cattail flour, acorn flour, sorghum flour, or tapioca flour, or a combination of two or more thereof. The flour, in this case wheat flour, is incorporated in amount of no more than 25% by weight of the meat mixture.

The aroma compound or flavoring compound, provide palatability enhancement respectively and include, but are not limited to, garlic (e.g., garlic concentrate, garlic oil, garlic powder, garlic aroma), onion (e.g., onion concentrate, onion oil, onion powder, onion aroma), natural smoke flavor, hickory, mesquite, anchovy, chicken, lobster, tikka, tandoori, parsley, spinach, saffron, digestive (liquid stomach contents of an animal, e.g., chicken), phosphate, yeast, or enzymatic liver (pork, turkey or chicken), or any derivative thereof, or any combination of two or more thereof. Additionally salt may be added to enhance flavor and can also provide particle binding in forming meat mixture.

Coloring compounds provide cosmetic enhancement respectively and include, but are not limited to, caramel coloring, malliouse, allurared AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, Saffron, Sunset yellow FCF, tartrazine, titanium dioxide, turmeric, yellow 5. yellow 2, or any combination of two or more thereof.

The humectant can be used to reduce water activity. Water activity is a measure of the availability of water in a food for microbial growth such as molds. Water activity is a primary method of controlling antimicrobial or mold growth. One example range of water activity is an aW value of less than 0.7. The humectant including sugar, or sugar alcohols can be used in an amount between about 0% and about 20% by weight of the meat mixture, for example about 15% to 18% by weight of the meat mixture. The humectant, can include, but is not limited to fructose, dextrose, maltodextrin, honey, high-fructose corn syrup, maltose, brown sugar, coconut sugar, date sugar, sucanat, molasses, turbinado sugar, dextrin, glucose, sucrose. sucralose, glycerin or any derivative thereof, or any combination of two or more thereof.

The meat mixture may also include a mold inhibitor. A non-exclusive list of mold inhibitors include, but is not limited to, potassium Sorbate, cultured whey, calcium propionate, cultured dextrose, cultured yeast, benzoic acid, acetic acid, or plum powder, or any derivative thereof or any combination of two or more thereof.

A moisturizing compound can be used in a range of between 2% and 20%. For example, a moisturizing compound, such as water, will aid in formation of the meat mixture. For example, the moisture content of the meat mixture may be above 20% prior to drying the pet chew, but will achieve a moisture content below 20%, for example 18%, in the final pet chew product.

It should be appreciated that each of these ingredients other than the meat base is optional. Such as the ingredients with a percentage range starting at 0%.

After mixing the meat base with the auxiliary ingredients and optionally subjecting it to a vacuum in the tumbling device, the temperature of the mixture can be checked. If the temperature is too high the mixture can be cooled, by techniques such as the addition of CO₂. Conversely, if the temperature is too low additional heat is applied to facilitate the formation of the meat mixture.

Referring now to at least one example of a process of forming the pet chew 10 is described. The present process comprises forming the prepared foodstuff into portions 140. The foodstuff is typically transported to a production area and portioned. The finished foodstuff can be subject to a processing step such as extrusion or injection molding to form the portion 140 with a hole thereof approximately at the center thereof and through the portion. The process of forming the portions can be performed manually or automatically using standard industry processing equipment and facility. One skilled in the art will be able to select necessary parts and optimize the operational parameters to arrive at the portions and holes thereof with desired shape, size, thickness.

The process comprises assembling the pet chew 10 by positioning, such as stringing, the finished portion(s) 140 onto the finished chew stick 105. In one example embodiments, the step of assembling the pet chew 10 comprises providing a chew stick having a major body 105, a first end 120, and a second end 130, wherein at least one end 120 or 130 or both is removed from the major body; positioning the portion(s) 140 onto the major body 110 through the hole(s) 150 of the portion(s) 140; and attaching the at least one end 120 or 130 or both back to the major body 105, thereby forming the pet chew 10, wherein the first end 120 and the second end 130 are larger in size relative to the hole(s) 150 of the portion(s) 140, thereby securing the portion(s) 140 between the two ends and preventing the portion(s) 140 from sliding off the pet chew. It is noted that the ends 120 and 130 can be of any shape and configuration, including but not limited to bone end, knot, tie, ball, as long as the end is larger in size compared with the major body 105 and the hole 150 of the portions 140. The positioning step can be performed manually by hand or automatically by a machine or a robotic arm.

In other embodiments, the process of assembling the pet chew may comprise forming a chew stick 10 having a major body 105 and two end 120 and 130, wherein at least one of the two ends 120 and 130 is configured in size to receive the portion(s) 140 through the holes 150 thereof; positioning the portion(s) 140 onto the major body 105 through the hole(s) 150; and tying each of the at least one end 120 or 130 or both into a knot(s) that is larger in size relative to the major body 105 and the hole(s) 150. As discussed previously, the chew stick 10 may be made by soaking a rawhide sheet, and then twisting the rawhide thereby forming a rawhide chew stick with a desired length and size, and then drying the rawhide chew stick. The one or more portion(s) can be placed onto the rawhide chew stick, and subsequently the ends of the rawhide chew can be tied into desired knots or knotted structures before the rawhide chew stick is hardened. Similarly, the knot(s) is configured to be larger in size relative to the hole(s) of the portion(s), thereby preventing the portion(s) from sliding off the pet chew.

The process may optionally comprise drying the assembled pet chew. The pet chew can be transferred via conveyor or manual transportation to a drying oven. The drying step is in an oven at about 40° C. to about 60° C. In some example embodiments, the drying time is at least 5 hours. In related embodiments, the drying time is between 5 to 7 hours. Additionally the pet chew may further be baked. The optional baking step is at a temperature of at least 80° C. for at least 30 minutes. Once the baking step is finished, the pet chews are removed from the oven and allowed to cool. Cold air or any other cold gas is forced on the surface which transports the pet chews from the oven to packaging. Air or gas that is warmed by contact with the pet chews is re-circulated and passed through refrigerated plates to cool the air/gas and then the air/gas is blown again over the pet chew. This process can be repeated numerous times until the pet chews are cooled to a desired temperature. The dried portion(s) may be reinforced in strength and less fragile, and may also be less sticky and thereby improve the ability to move around or along the pet chew.

Upon drying, and optional quality control checks, the pet chews are transferred into packages. In one embodiment, air in the bags is displaced (either drawn via a vacuum or pushed with an inert gas or gas blend) So as to reduce the level of oxygen in the bags. Then the bags are filled with the pet chews and the bags are purged in an atmosphere filled with nitrogen or an inert gas such as argon, or a combination of these gases. In another embodiment, the bags are filled with the portions of pet chews in a modified atmosphere containing nitrogen, inert gas (e.g., argon). carbon dioxide, or carbon monoxide, or any combination of two or more these gases.

Any of these gasses can comprise about 0% to about 100% by weight of the gas composition. In one embodiment, the bags of pet chews comprise an atmosphere that includes nitrogen gas, carbon dioxide, and carbon monoxide. The purpose of the gas introduction is to reduce the amount of oxygen in the bag. In at least one example embodiment, the resulting pet chew is made such that it does not leave sticky or oily residue on the fingers of the pet owner or consumer who handles the pet chew. In general, typical meat or meat-based products include cooked meat with meat juice or fat may not be desirable by the pet owner or consumer. Alternatively, the pet chews described herein offer a more suitable handling. To state another way, the pet chew leaves a minimum amount of residue on the fingers of the consumer. Moreover, the one or more portions allows for a pet chew that has increased palatability and good ingredients.

For example, the addition of flour (e.g., wheat flour) can help soak up the fat content in the foodstuff for the portions, hence substantially reducing the potential of having a sticky residue when handling the pet chews. In addition, special blending techniques (e.g., vacuum blending as described in the above paragraphs) and other processes or techniques, maximize blending and reduce the occurrence of large chunks of meat in the foodstuff for the portions. The use of a dry oven with reduced humidity, as described in the above paragraphs, can produce pet chews with a substantially dry outer surface. This outer surface can form an outer dry surface to minimize the moisture from the one or more portions from bleeding out. Further, because the one or more portions are dried and the flavoring is found homogenously mixed the likelihood of transferring any dye or flavoring to a decorative surface is reduced because the dye or flavoring is less prone to contacting the decorative surface and is less prone to rub off if it does contact the decorative surface.

While various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. In fact, after reading the above description, it will be apparent to one skilled in the relevant art(s) how to implement the disclosure in alternative embodiments. Thus, the present disclosure should not be limited by any of the above-described exemplary embodiments. Accordingly, all suitable modifications and equivalents should be considered as falling within the spirit and scope of the disclosure.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

1. A pet chew comprising:
a chew stick having a longitudinal axis, a, first end and a second end; and
one or more portions disposed onto the chew stick,
wherein the one or more portions are rotatable around the longitudinal axis; and wherein the one or more portions have a thickness from about 0.1 cm to about 5 cm, or from about 0.2 cm to about 4 cm, or from about 0.3 cm to about 3 cm, or from about 0.4 cm to about 2 cm, or from about 0.5 cm to about 1 cm.

2. The pet chew of claim 1, wherein each of the one or more portions has a hole and the one or more portions are strung onto the chew stick through the hole(s) positioned in approximately the center of each of the one more portions.

3. The pet chew of claim 1, wherein the chew stick has a major body extended from a first end to a second end, wherein major body has a substantially uniform cross-section through a length of the major body.

4. The pet chew of claim 1, wherein the first end and the second end each has a larger cross-section in size or circumference relative to the major body.

5. The pet chew of claim 1, wherein the hole of each of the portions is larger in size relative to the cross-section of the major body, such that the one or more portions can both rotate around the major body and move along the major body.

6. The pet chew of claim 1, wherein the first end the second end are larger in size relative to the hole of each of the one or more portions, thereby preventing the portions from sliding off the pet chew.

7. The pet chew of claim 1, further comprising at least one knot disposed at the first end or the second end or both, wherein the knot(s) is larger in size relative to the hole of each of the one or more portions.

8. The pet chew of claim 1, wherein the chew stick is substantially straight.

9. (canceled)

10. The pet chew of claim 1, wherein at least one of the portions has a disk-like configuration.

11. The pet chew of claim 1, wherein at least one of the portions has a substantially round shape.

12. (canceled)

13. The pet chew of claim 1, wherein the pet chew comprises two or more portions and wherein the two or more portions are substantially the same in shape, size, and thickness.

14. The pet chew of claim 1, wherein the chew stick comprises rawhide.

15. The pet chew of claim 1, wherein the chew stick is substantially free from rawhide.

16. The pet chew of claim 1, wherein the chew stick comprises a natural animal portion selected from the group consisting of pizzle, bone, tendon, ligament, sinew, weasand (esophagus) and combinations thereof.

17. The pet chew of claim 1, wherein the one or more portions comprise a meat selected from the group consisting of pork, beef, chicken, duck, goat, horse, buffalo, venison, deer, elk, moose, liver, fish, veal, lamb, turkey, goose and combinations thereof.

18. The pet chew of claim 1, wherein the one or more portions comprise a plant selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugh fruit and combinations thereof.

19. The pet chew of claim 1, wherein the one or more portions comprise a plant selected from a group consisting of artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

20. The pet chew of claim 1, wherein the one or more portions comprise one or more auxiliary ingredients selected from the group consisting of a binding agent, a moisturizing compound, a salt, a sugar, an acid, a mold inhibitor, a flavoring compound, an aroma compound, a coloring compound and any combination of two or more thereof.

21. The pet chew of claim 1, further comprising a food additive selected from the group of preservative, sorbitol, desired colorant, glycerin, yeast extract, flavor, salt, cochineal, potassium sorbate, or combinations thereof.

22. The pet chew of claim 1, further comprising a health ingredient selected from the group consisting of glucosamine, chondroitin, flax seed, calcium, parsley seed, peppermint, chlorophyll, vitamin E, L-carnitine, and lycopene, and combinations thereof.

23. The pet chew of claim 1, further comprising one or more coloring compounds selected from a group consisting of caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof.

24. A process of making a pet chew, the process comprising:
providing a chew stick, the chew stick having a longitudinal axis, a first end and a second end; and
disposing one or more portions onto the chew stick,
wherein each of the one or more portions are rotatable around the longitudinal axis; and
wherein the one or more portions have a thickness from about 0.1 cm to about 5 cm, or from about 0.2 cm to about 4 cm, or from about 0.3 cm to about 3 cm, or from about 0.4 cm to about 2 cm, or from about 0.5 cm to about 1 cm.

25. The process of claim 24, the disposing step comprises:
providing one or more portions, each portion having a hole; and
positioning the one or more portions onto the chew stick through the hole(s).

26. The process of claim 24, wherein the chew stick has a major body extended from a first end to a second end, wherein major body has a substantially uniform cross-section through a length of the major body.

27. The process of claim 26, further comprising a means to configure the first end and the second end of the chew stick, such that the first end the second end are larger in size or circumference relative to the hole of each of the one or more portions, thereby preventing the portions from sliding off the pet chew.

28. The process of claim 27, wherein the chew stick is formed by twisting a rawhide sheet, and wherein the means to configure the first end and the second end of the chew stick comprises making a tied knot at each of the first end and the second end of the twisted rawhide sheet.

29-39. (canceled)
